(19) United States
(12) Patent Application Publication
(10) Pub. No.: US 2016/0227792 A1
(43) Pub. Date: Aug. 11, 2016

(54) PROTEIN-BASED PIZZA CRUST

(71) Applicant: MOHAMED ELHOSINY ALY, WESTCHESTER, IL (US)

(72) Inventor: MOHAMED ELHOSINY ALY, WESTCHESTER, IL (US)

(21) Appl. No.: 15/134,364

(22) Filed: Apr. 20, 2016

Related U.S. Application Data
(63) Continuation-in-part of application No. 13/691,831, filed on Dec. 2, 2012.
(60) Provisional application No. 61/566,393, filed on Dec. 2, 2011.

(51) Int. Cl. A21D 13/00

(52) U.S. Cl. CPC A21D 13/007; A23L 1/3152; A23V 2002/00

(57) ABSTRACT

Essentially carbohydrate-free, protein-based pizza crusts and methods for preparing the same are disclosed herein. The organoleptic properties of the disclosed pizza crusts preferably resemble the organoleptic properties of traditional baked goods and are substantially different from the organoleptic properties of traditional meat products. The disclosed pizza crusts comprise a meat or nut flour, a flavor-masking spice, salt, and a vegetable, fruit, or plant-based oil or an oil-based spray. The disclosed pizza crusts preferably resemble traditional pizza crusts in both appearance and taste.

### CROSS-REFERENCE TO RELATED APPLICATIONS

This application is a continuation-in-part of U.S. patent application Ser. No. 13/691,831, filed on Dec. 2, 2012, which claims the benefit of and priority to U.S. Provisional Patent Application Ser. No. 61/566,393, filed on Dec. 2, 2011.

### BACKGROUND

1. Field of the Invention

The present disclosure relates to an essentially carbohydrate-free, protein-based pizza crust.

2. Description of the Related Art

Although pizza is Italian in origin, it is now an extremely popular food both in the United States and worldwide. Pizza is generally known as an unhealthy food, as it is often high in calories, fat, carbohydrates, and salt. As the medical profession warns of the dangers of unhealthy eating, people in the United States and worldwide are now seeking alternative forms of popular foods such as pizza. In particular, individuals suffering from Type II diabetes and others seek to limit their carbohydrate intake. As pizza crust is typically made from carbohydrate-rich flour-based dough products, the availability of a substantially carbohydrate-free pizza crust would enable such individuals to continue eating and enjoying pizza while remaining within their chosen or medically-necessary dietary restrictions.

Although previous attempts at preparing substantially carbohydrate-free pizza crusts have focused primarily on the use of flour-based products, some efforts have been made to prepare meat-based pizza crusts. See, e.g., lowcarbdiets.about.com/od/maindishes/r/meatzapizza.htm; www.rebelspatula.com/index.php/paleo? start=45; lowcarb.betterrecipes.com/sausage-pizza.html; badgerandblade.com/vb/showthread.php/206841. However, the pizza industry has thus far been unable to devise a general method of using meat to form a useable pizza crust. Previous attempts to prepare a low carbohydrate pizza crust using sausage have apparently not yielded commercially successful products. See, e.g., chicago.seriouseats.com/2008/06/lou-malnatis-chicago-deep-dish-pizza-sausage-crust-gluten-free.html. Moreover, sausage-based pizza crusts are apparently not currently readily commercially available. In addition, previous attempts at preparing substantially carbohydrate-free pizza crusts have generated crusts that do not taste like traditional pizza crusts, which limits the usefulness of these products. See, e.g., www.eat-drink-smile.com/2011/04/cauliflower-crust-pizza.html .

### SUMMARY

Essentially carbohydrate-free, protein-based pizza crusts and methods for preparing the same are disclosed herein. The organoleptic properties of the disclosed pizza crusts preferably resemble the organoleptic properties of traditional baked goods and are substantially different from the organoleptic properties of traditional meat products. The disclosed pizza crusts comprise a meat or nut flour, a flavor-masking spice, salt, and a vegetable, fruit, or plant-based oil or an oil-based spray. The disclosed pizza crusts preferably resemble traditional pizza crusts in both appearance and taste.

### DETAILED DESCRIPTION OF THE PREFERRED EMBODIMENTS

The present disclosure describes essentially carbohydrate-free, protein-based pizza crusts and methods for preparing the same. The pizza crust base comprises meat or a nut flour, a flavor-masking spice, salt, and a vegetable, fruit, or plant-based oil or an oil-based spray. The pizza crust base is preferably fiber-free and does not contain any other non-digestible carbohydrates.

### Ingredients

In some embodiments, the pizza crust base comprises ingredients in the following ratios: about 40 pounds of meat or a nut flour, about ¼-¾ tablespoon of a flavor-masking spice, about 4-7 tablespoons of salt, and about 2-5 fluid ounces of a vegetable, fruit, or plant-based oil or an oil-based spray.

The meat may preferably be poultry, more preferably chicken, most preferably boneless chicken breast. The flavor-masking spice may preferably be nutmeg, cardamom, or mastic, most preferably nutmeg. The salt may be sea salt, table salt, rock salt, or another salt comprising greater than 95% sodium chloride, more preferably sea salt or table salt, most preferably sea salt. The oil or oil-based spray may preferably be olive oil or an olive oil spray, most preferably an olive oil spray.

In preferred embodiments, the pizza crust base comprises ingredients in the following ratios: about 40 pounds of poultry, about ⅖-½ tablespoon of nutmeg, about 5-6 tablespoons of salt, and about 3-4 fluid ounces of olive oil or olive oil spray.

In more preferred embodiments, the pizza crust base comprises ingredients in the following ratios: about 40 pounds of boneless chicken breast, about ⅖-½ tablespoon of nutmeg, about 5-6 tablespoons of salt, and about 3-4 fluid ounces of olive oil or olive oil spray.

In highly preferred embodiments, the pizza crust base comprises ingredients in the following ratios: about 40 pounds of boneless chicken breast, about 6/13 tablespoon of nutmeg, about 5 7/13 tablespoons of salt, and about 3½ fluid ounces of olive oil spray. These embodiments may further include no additional carbohydrate-containing ingredients.

Boneless chicken breast, sea salt, and olive oil contain no carbohydrates, and the amount of carbohydrates introduced by using nutmeg is negligible. See ndb.nal.usda.gov/ndb/foods. Thus a pizza crust base comprising these ingredients and including no additional carbohydrate-containing ingredients is essentially carbohydrate-free.

### Preparation of Pizza Crust

In preferred embodiments, the pizza crust is prepared from the ingredients that comprise the pizza crust base according to the method described below.

In more preferred embodiments, if meat is used, substantially all fats and connective tissues are removed from the meat and the meat is then cut into small pieces to yield cubed meat. The pieces of meat may preferably be approximately cubic and approximately 1-2 inches per side.

In more preferred embodiments, the salt and the flavor-masking spice are thoroughly premixed to yield a salt/spice mixture. In highly preferred embodiments, about 60 tablespoons of salt and about 5 tablespoons of the flavor-masking spice are premixed, and about 6 tablespoons of this salt/spice mixture are added to 40 pounds of cubed meat. Other highly preferred embodiments may use the same ratios but different absolute amounts of salt, the flavor-masking spice, and meat. The salt and flavor-masking spice may preferably be premixed by hand. In alternative embodiments, the appropriate amount of salt and the flavor-masking spice are added directly to the cubed meat without premixing. In other alternative embodiments, the salt/spice mixture or the non-premixed salt and spice are added to a nut flour.

The cubed meat or nut flour is thoroughly mixed with the salt/spice mixture or the non-premixed salt and spice to yield a seasoned meat mixture. The cubed meat or nut flour and the salt/spice mixture or the non-premixed salt and spice may preferably be mixed by hand.

The seasoned meat mixture is then ground one or more times according to the following procedure. The seasoned meat mixture may preferably be ground more than once. The seasoned meat mixture is placed into a grinding device such as a grinder, food processor, blender, or similar small appliance, thoroughly ground, and removed from the grinding device to yield a first ground meat mixture. The first ground meat mixture is then preferably placed into the grinding device again, thoroughly ground again, and then removed from the grinding device to yield a second ground meat mixture. The grinding procedure may be repeated as many times as is necessary to achieve the desired consistency for the ground meat mixture. The ground meat mixture generated by the final iteration of the grinding procedure is subsequently used to prepare the pizza crust.

The ground meat mixture, preferably the second ground meat mixture, is then formed into dough balls. Each dough ball may preferably weigh between about 6-16 ounces. To prepare an 8-inch pizza crust, a dough ball may preferably weigh between about 7-9 ounces, more preferably about 8 ounces. To prepare a 14-inch pizza crust, a dough ball may preferably weigh between about 13-15 ounces, more preferably about 14 ounces. Each dough ball is coated with the appropriate amount of oil or oil-based spray to yield an oil-coated dough ball. Preferably, each dough ball is sprayed with about 1-4 sprays of olive oil spray, more preferably 1-2 sprays. The oil or oil-based spray reduces adhesion of the dough ball to other materials. The oil-coated dough ball serves as the base for the pizza crust.

The oil-coated dough ball is then placed into approximately the center of a dough press. In more preferred embodiments, before placing the oil-coated dough ball in the dough press, the oil-coated dough ball is placed on a sheet of aluminum foil and parchment paper or another material that assists in generating a non-stick environment is placed on top of the oil-coated dough ball. A metal pan may preferably be placed above the bottom section of the dough press, underneath the top section of the dough press, parchment paper, oil-coated dough ball, and aluminum foil sheet. The metal pan may comprise stainless steel, cast iron, aluminum, copper, or another metal or alloy. The metal pan may preferably be a stainless steel pan. The metal pan may preferably be circular.

The oil-coated dough ball is then pressed into a raw pizza crust using the dough press. The raw pizza crust may preferably be circular. The parchment paper may preferably be removed before baking the raw pizza crust.

The raw pizza crust is then baked, preferably in a pre-heated oven, at a temperature between about 300-600 degrees Fahrenheit for about 3-15 minutes. In more preferred embodiments, the raw pizza crust is baked in a pre-heated oven between about 550-600 degrees Fahrenheit for between 7-8 minutes. In highly preferred embodiments, the raw pizza crust is baked at about 575 degrees Fahrenheit for about 7½ minutes.

The pizza crust is then removed from the oven and allowed to stand at ambient temperature for a period of time. The period of time may preferably be between about 5 minutes-2 hours, more preferably about 15 minutes.

The crust is then ready to be used for its designated purpose. The crust may be wrapped and frozen, and may be used for up to about 3 months.

The organoleptic properties of pizza crusts prepared according to the disclosed methods preferably resemble the organoleptic properties of traditional baked goods and are substantially different from the organoleptic properties of traditional meat products. Pizza crusts prepared according to the disclosed methods preferably are substantially similar to crusts of traditional thin crust pizza in both appearance and taste. For example, when boneless chicken breast is used to prepare the crust, the crust unexpectedly does not taste like chicken but instead tastes substantially similar to a traditional flour-based pizza crust.

The previous description of the disclosed embodiments is provided to enable any person skilled in the art to make or use the invention disclosed herein. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments described herein but is to be accorded the widest scope consistent with the principles and novel features disclosed herein. All references cited herein are expressly incorporated by reference.

What is claimed is:

1. A method of preparing a pizza crust using a pizza crust base comprising meat or a nut flour, salt, a flavor-masking spice, and a vegetable, fruit, or plant-based oil or oil-based spray,
wherein the pizza crust base is essentially carbohydrate-free and essentially fiber-free;
wherein the method comprises the steps of:
a. mixing the salt and the flavor-masking spice or an appropriate amount of a premixed salt/spice mixture with the meat or nut flour to yield a seasoned meat mixture;
b. placing the seasoned meat mixture in a grinding device;
c. grinding the seasoned meat mixture one or more times to yield a ground meat mixture;
d. forming a dough ball from a portion of the ground meat mixture;
e. applying oil to the surface of the dough ball to yield an oil-coated dough ball;
f. placing the oil-coated dough ball in a dough press;
g. pressing the oil-coated dough ball with the dough press to generate a raw pizza crust;
h. baking the raw pizza crust in an oven to yield a pizza crust; and
i. removing the pizza crust from the oven and allowing it to stand at ambient temperature for a period of time;
wherein the organoleptic properties of the pizza crust resemble the organoleptic properties of traditional baked goods and are substantially different from the organoleptic properties of traditional meat products; and
wherein the pizza crust is substantially similar to crusts of traditional thin crust pizza in both appearance and taste.

2. The method of claim 1 wherein the meat is boneless chicken breast, the flavor-masking spice is nutmeg, and the oil is olive oil or an olive oil spray.

3. The method of claim 2 wherein the ingredients are used in the following ratios:
a. about 40 pounds of boneless chicken breast;
b. about ⅖-½ tablespoon of nutmeg;
c. about 5-6 tablespoons of salt; and
d. about 3-4 fluid ounces of olive oil or an olive oil spray.

4. The method of claim 3 wherein the salt and nutmeg are premixed to yield a salt/spice mixture prior to mixing with the boneless chicken breast.

5. The method of claim 3 wherein substantially all fats and connective tissues are removed from the boneless chicken breast and the boneless chicken breast is then cut into small pieces prior to mixing the boneless chicken breast with the salt and the flavor-masking spice or the appropriate amount of the salt/spice mixture.

6. The method of claim 3 wherein the seasoned meat mixture is ground twice.

7. The method of claim 3 wherein each dough ball weighs between about 6-16 ounces.

8. The method of claim 3 wherein the olive oil or olive oil spray is an olive oil spray.

9. The method of claim 8 wherein 1-2 sprays of the olive oil spray are used.

10. The method of claim 3 wherein the oil-coated dough ball is placed on a sheet of aluminum foil and wherein parchment paper or another material that assists in generating a non-stick environment is placed on top of the oil-coated dough ball before the oil-coated dough ball is placed in the dough press.

11. The method of claim 10 wherein a metal pan is placed underneath the sheet of aluminum foil.

12. The method of claim 11 wherein the metal pan is a stainless steel pan.

13. The method of claim 11 wherein the parchment paper or other material that assists in generating a non-stick environment is removed before baking the raw pizza crust.

14. The method of claim 3 wherein the raw pizza crust is baked in a pre-heated oven at a temperature between about 300-600 degrees Fahrenheit for about 3-15 minutes.

15. The method of claim 14 wherein the raw pizza crust is baked in a pre-heated oven between about 550-600 degrees Fahrenheit for between 7-8 minutes.

16. The method of claim 15 wherein the raw pizza crust is baked at about 575 degrees Fahrenheit for about 7½ minutes.

17. The method of claim 3 wherein the period of time is between about 5 minutes-2 hours.

18. The method of claim 17 wherein the period of time is about 15 minutes.

19. The method of claim 4 wherein:
substantially all fats and connective tissues are removed from the boneless chicken breast and the boneless chicken breast is then cut into small pieces prior to mixing the boneless chicken breast with an appropriate amount of the salt/spice mixture;
the seasoned meat mixture is ground twice;
each dough ball weighs between about 6-16 ounces;
the olive oil or olive oil spray is an olive oil spray and is applied by spraying 1-2 sprays of the olive oil spray onto the dough ball to yield an oil-coated dough ball;
the oil-coated dough ball is placed on a sheet of aluminum foil, the sheet of aluminum foil is placed in a stainless steel pan, and parchment paper or another material that assists in generating a non-stick environment is placed on top of the oil-coated dough ball before the oil-coated dough ball is placed in the dough press, and the parchment paper or other material that assists in generating a non-stick environment is removed before baking the raw pizza crust;
the raw pizza crust is baked at about 575 degrees for about 7½ minutes; and
the period of time is about 15 minutes.

20. The method of claim 19 wherein the ingredients are used in the following ratios:
a. about 40 pounds of boneless chicken breast;
b. about 6/13 tablespoon of nutmeg;
c. about 5 7/13 tablespoons of salt; and
d. about 3½ fluid ounces of an olive oil spray;
and wherein the pizza crust base further comprises no additional carbohydrate-containing ingredients.
